(19) United States
(12) Patent Application Publication
(10) Pub. No.: US 2026/0039185 A1
(43) Pub. Date: Feb. 5, 2026

(54) CONTROL METHOD FOR CASCADING SYSTEM, AND CASCADING SYSTEM

(71) Applicant: Delta Electronics (Shanghai) Co., Ltd., Shanghai (CN)

(72) Inventors: Hong LIU, Shanghai (CN); Sanyuan OUYANG, Shanghai (CN); Yuxin HAN, Shanghai (CN); Wen ZHANG, Shanghai (CN); Baihui SONG, Shanghai (CN)

(21) Appl. No.: 19/276,020

(22) Filed: Jul. 22, 2025

(30) Foreign Application Priority Data
Aug. 5, 2024 (CN) 202411070074.2

(51) Int. Cl. H02M 1/00

(52) U.S. Cl. CPC H02M 1/007; H02M 1/0032; H02M 1/0043

(57) ABSTRACT

The present application provides a control method for a cascading system, and a cascading system. The cascading system includes a first port and N power modules, N is an integer greater than or equal to 2, each of the power modules includes a first port and a second port, first ports of the N power modules are connected in series and are then connected to the first port of the cascading system. A voltage across the first port of at least one power module is controlled to be between a voltage corresponding to an n1-th level and a voltage corresponding to an n2-th level during part of time in a switching period, n1 and n2 are adjacent integers, so that the cascading system operates in a current discontinuous conduction mode, thereby achieving discontinuous inductor current flow and zero steady-state error tracking of the reference value.

### CROSS-REFERENCE TO RELATED APPLICATION

This application claims priority to Chinese Patent Application No. 202411070074.2, filed on Aug. 5, 2024, which is hereby incorporated by reference in its entirety.

### TECHNICAL FIELD

The present application relates to the field of power electronic technologies and, in particular, to a control method for a cascading system, and a cascading system.

### BACKGROUND

A solid state transformer using a modular cascading system has broad application prospects in data centers, electric vehicle charging and swapping stations, photovoltaics, energy storage, and other fields. However, as shown in FIG. 1, a power supply system using a solid state transformer is less efficient under a light load. Therefore, a study on a method to improve the efficiency of the modular cascading system under a light load is of significant importance for promoting application of the solid state transformer.

In prior arts, a Burst mode is used under a light load, and an ON-OFF state of a converter is controlled according to a magnitude of an output voltage to improve efficiency. However, this method is disadvantageous in that a current waveform is usually poor, and it is generally used in standby or particular light load (such as <5% load) situations. In addition, depending on whether an inductor current of a cascading system is continuous, the converter may operate in three working modes: a current continuous conduction mode (CCM), a current critical conduction mode (CRM), and a current discontinuous conduction mode (DCM), respectively. As shown in FIG. 2, a switching frequency can be reduced by adopting the DCM mode under the light load, and a switch can achieve zero-current turning-on without diode reverse recovery loss, thereby improving efficiency. However, this efficiency improving method is only applicable to a single module, and a problem with regard to the efficiency under the light load has not yet been resolved in the modular cascading system.

### SUMMARY

The present application provides a control method for a cascading system and a cascading system, which provides a solution to improve the efficiency under a light load for the cascading system to overcome deficiencies in prior arts.

In a first aspect, the present application provides a control method for a cascading system, where the cascading system includes a first port and N power modules, N is an integer greater than or equal to 2, each of the power modules includes a first port and a second port, first ports of the N power modules are connected in series and are then connected to the first port of the cascading system; the control method includes:
controlling a voltage across the first port of at least one power module to be between a voltage corresponding to an n1-th level and a voltage corresponding to an n2-th level during part of time in a switching period, so that the cascading system operates in a current discontinuous conduction mode, where n1 and n2 are adjacent integers.

In a possible design, the cascading system further includes an inductor, the first port of the cascading system is connected to a voltage source through the inductor, the controlling the voltage across the first port of the at least one power module to be between the voltage corresponding to the n1-th level and the voltage corresponding to the n2-th level during the part of time in the switching period includes:
phase-shifting carrier signals corresponding to the N power modules by 2π/N in sequence;
according to an inductance of the inductor, an equivalent switching frequency of the cascading system, a current setpoint of the first port of the cascading system, a voltage setpoint of the first port of the cascading system, and a voltage across the second port of the power module and N, performing a calculation based on the cascading system operating in the current discontinuous conduction mode, to generate a first duty cycle and a second duty cycle;
determining a driving signal of a switch in each of the power modules according to the first duty cycle, the second duty cycle, and the carrier signal of each of the power modules.

In a possible design, the voltage setpoint of the first port of the cascading system is equal to a voltage of the voltage source.

In a possible design, the method further includes:
obtaining a current error according to the current setpoint of the first port of the cascading system and a current feedback value of the first port of the cascading system, and modulating the current error to obtain an intermediate voltage; and
subtracting the intermediate voltage from the voltage of the voltage source to obtain the voltage setpoint of the first port of the cascading system.

In a possible design, the method further includes:
according to the voltage setpoint of the first port and the voltage across the second port of the power module, performing a calculation based on the cascading system operating in the current continuous conduction mode, to obtain a third duty cycle and a fourth duty cycle; and
determining the driving signal of the switch in each of the power modules according to a minimum value of the first duty cycle and the third duty cycle, a minimum value of the second duty cycle and the fourth duty cycle, and the carrier signal of each of the power modules.

In a possible design, the cascading system further includes an inductor, the first port of the cascading system is connected to a voltage source through the inductor, the controlling the voltage across the first port of the at least one power module to be between the voltage corresponding to the n1-th level and the voltage corresponding to the n2-th level during the part of time in the switching period includes:
determining a number of high-frequency power modules to be one or two according to a voltage of the voltage source, where the high-frequency power module refers to a power module operating in a high-frequency modulation mode.

In a possible design, the determining the number of high-frequency power modules according to the voltage of the voltage source includes:
if a ratio of the voltage of the voltage source to N times a voltage across the second port of the power module is less than a preset ratio, determining that the number of high-frequency power modules is one;
if a ratio of the voltage of the voltage source to N times a voltage across the second port of the power module is greater than or equal to the preset ratio, determining that the number of high-frequency power modules is two.

In a possible design, the preset ratio is 0.2.

In a possible design, when the number of high-frequency power modules is two, the method further includes:
if an input voltage of the high-frequency power module is an integer multiple of an output voltage, synchronously controlling the high-frequency power modules; and
if an input voltage of the high-frequency power module is not an integer multiple of an output voltage, non-synchronously controlling the high-frequency power modules.

In a possible design, the non-synchronously controlling includes one of the following situations: simultaneously turning on the high-frequency power modules and non-simultaneously turning off the high-frequency power modules; non-simultaneously turning on the high-frequency power modules and simultaneously turning off the high-frequency power modules; or non-simultaneously turning on the high-frequency power modules and non-simultaneously turning off the high-frequency power modules.

In a possible design, the high-frequency power module is determined by time-based rotation or sequential rotation of the N power modules.

In a second aspect, the present application provides a cascading system, including: a first port and N power modules, where N is an integer greater than or equal to 2, each of the power modules includes a first port and a second port, first ports of the N power modules are connected in series and are then connected to the first port of the cascading system; and
a control unit, configured to control a voltage across the first port of at least one power module to be between a voltage corresponding to an n1-th level and a voltage corresponding to an n2-th level during part of time in a switching period, so that the cascading system operates in a current discontinuous conduction mode, where n1 and n2 are adjacent integers.

In a possible design, the cascading system further includes an inductor, the first port of the cascading system is connected to a voltage source through the inductor, and the control unit is specifically configured to:
phase-shift carrier signals corresponding to the N power modules by 2π/N in sequence;
according to an inductance of the inductor, an equivalent switching frequency of the system, a current setpoint of the first port of the cascading system, a voltage setpoint of the first port of the cascading system, and a voltage across the second port of the power module and N, perform a calculation based on the cascading system operating in the current discontinuous conduction mode, to generate a first duty cycle and a second duty cycle;
determine a driving signal of a switch in each of the power modules according to the first duty cycle, the second duty cycle, and the carrier signal of each of the power modules.

In a possible design, the voltage setpoint of the first port of the cascading system is equal to a voltage of the voltage source.

In a possible design, the control unit is further configured to:
obtain a current error according to the current setpoint of the first port of the cascading system and a current feedback value of the first port of the cascading system, and modulate the current error to obtain an intermediate voltage; and
subtract the intermediate voltage from the voltage of the voltage source to obtain the voltage setpoint of the first port of the cascading system.

In a possible design, the control unit is further configured to:
according to the voltage setpoint of the first port and the voltage across the second port of the power module, perform a calculation based on the cascading system operating in the current continuous conduction mode, to obtain a third duty cycle and a fourth duty cycle; and
determine the driving signal of the switch in each of the power modules according to a minimum value of the first duty cycle and the third duty cycle, a minimum value of the second duty cycle and the fourth duty cycle, and the carrier signal of each of the power modules.

In a possible design, the cascading system further includes an inductor, the first port of the cascading system is connected to a voltage source through the inductor, and the control unit is further configured to:
determine a number of high-frequency power modules to be one or two according to a voltage of the voltage source, where the high-frequency power module refers to a power module operating in a high-frequency modulation mode.

In a possible design, the control unit is further configured to:
if a ratio of the voltage of the voltage source to N times a voltage across the second port of the power module is less than a preset ratio, determine that the number of high-frequency power modules is one;
if a ratio of the voltage of the voltage source to N times a voltage across the second port of the power module is greater than or equal to the preset ratio, determine that the number of high-frequency power modules is two.

In a possible design, the preset ratio is 0.2.

In a possible design, when the number of high-frequency power modules is two, the control unit is further configured to:
if an input voltage of the high-frequency power module is an integer multiple of an output voltage, synchronously control the high-frequency power modules; and
if an input voltage of the high-frequency power module is not an integer multiple of an output voltage, non-synchronously control the high-frequency power modules.

In a possible design, the non-synchronously controlling includes one of the following situations: simultaneously turning on the high-frequency power modules and non-simultaneously turning off the high-frequency power modules; non-simultaneously turning on the high-frequency power modules and simultaneously turning off the high-frequency power modules; or non-simultaneously turning on the high-frequency power modules and non-simultaneously turning off the high-frequency power modules.

In a possible design, the high-frequency power module is determined by time-based rotation or sequential rotation of the N power modules.

### BRIEF DESCRIPTION OF DRAWINGS

In order to explain the embodiments of the present application or the technical solutions in the prior art more clearly, the drawings needed to be used in the embodiments or the description of the prior art will be introduced briefly in the following. Obviously, the drawings in the following description are intended for some embodiments of the present application. For those ordinarily skilled in the art, other drawings can be obtained from these drawings without any creative effort.

FIG. 1 is a schematic diagram of efficiency of a power supply system for a solid state transformer according to a prior art.

FIG. 2 is a schematic diagram of inductor current waveforms under different control modes according to a prior art.

FIG. 3 is a schematic structural diagram of a cascading system according to an embodiment of the present application.

FIG. 4 is a schematic diagram of a simulation effect according to an embodiment of the present application.

FIG. 5 is a control block diagram according to an embodiment of the present application.

FIG. 6 is a schematic diagram of implementing a DCM based on carrier phase-shifting according to an embodiment of the present application.

FIG. 7 is another control block diagram according to an embodiment of the present application.

FIG. 8 is a schematic diagram of another simulation effect according to an embodiment of the present application.

FIG. 9 is a schematic diagram of yet another simulation effect according to an embodiment of the present application.

FIG. 10 is a schematic diagram of non-synchronous DCM control between power modules according to an embodiment of the present application.

FIG. 11 is different situations of non-synchronous control according to an

embodiment of the present application.

FIG. 12 is a schematic structural diagram of another cascading system according to an embodiment of the present application.

FIG. 13 is a schematic diagram of a calculation process for a duty cycle and a switching frequency according to an embodiment of the present application.

FIG. 14 is a block diagram of determining an error based on a mean current according to an embodiment of the present application.

FIG. 15 is a schematic diagram of an operation effect of a cascading system under quadrilateral DCM control according to an embodiment of the present application.

FIG. 16 is a schematic structural diagram of yet another cascading system according to an embodiment of the present application.

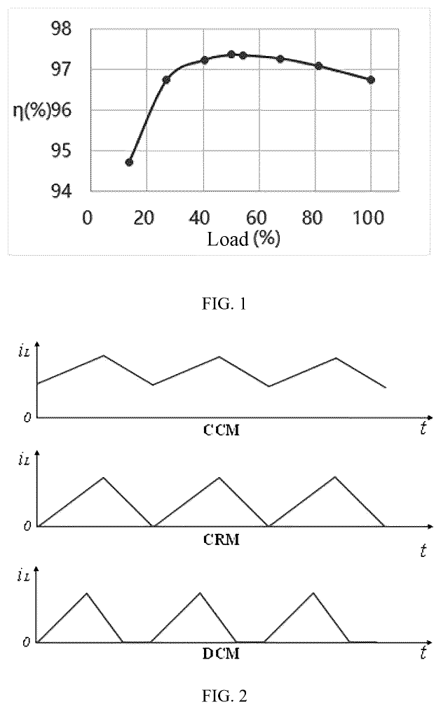

### DESCRIPTION OF EMBODIMENTS

The exemplary embodiments will be described in detail here, with examples shown in the accompanying drawings. When referring to the accompanying drawings, unless otherwise indicated, the same numbers in different drawings represent the same or similar elements. The implementations described in the following exemplary embodiments do not represent all implementations consistent with the present application. On the contrary, they are only examples of methods and apparatuses consistent with some aspects of the present application as described in the appended claims.

The terms “first”, “second”, “third”, “fourth”, etc. (if any) in the specification and claims and the above accompanying drawings of the present application are used to distinguish similar objects and do not necessarily describe a specific order or sequence. It should be understood that the data used in this way is interchangeable in appropriate situations, so that the embodiments described herein can be implemented in order other than those shown or described herein. In addition, the terms “include” and “have” and any variations thereof, are intended to cover non-exclusive inclusions, for example, processes, methods, systems, products, or devices that contain a series of steps or units are not necessarily limited to those clearly listed, but may include other steps or units that are not clearly listed or inherent to these processes, methods, products, or devices.

In prior arts, a Burst mode is used under a light load, and an ON-OFF state of a converter is controlled according to a magnitude of an output voltage to improve efficiency. However, this method is disadvantageous in that a current waveform is usually poor, and it is generally used in standby or particular light load (such as <5% load) situations. In addition, depending on whether an inductor current of a cascading system is continuous, the converter may operate in three working modes: a CCM, a CRM, and a DCM respectively. As shown in FIG. 2, switching frequency can be reduced by adopting the DCM mode under the light load, and a switch can achieve zero-current turning-on, without diode reverse recovery loss, thereby improving efficiency. However, this efficiency improving method is only applicable to a single module, and a problem with regard to the efficiency under the light load has not yet been resolved in a modular cascading system.

As for the above-described problems in the prior arts, the present application provides a control method for a cascading system and a cascading system. An inventive concept of the control method for the cascading system provided in the present application lies in that the cascading system may include a first port and N power modules, N is an integer greater than or equal to 2, each of the power modules includes a first port and a second port, first ports of the N power modules are connected in series and are then connected to the first port of the cascading system. By controlling a voltage across the first port of at least one power module to be between a voltage corresponding to an n1-th level and a voltage corresponding to an n2-th level during part of time in a switching period, n1 and n2 are adjacent integers, so that the cascading system operates in a current discontinuous conduction mode, thereby achieving discontinuous inductor current flow and zero steady-state error tracking of the reference value. A solution of controlling the cascading system under a light load is provided, which can reduce a turning-on current of the power module under the light load, achieve zero-current turning-on, and improve efficiency under the light load.

FIG. 3 is a schematic structural diagram of a cascading system according to an embodiment of the present application. As shown in FIG. 3, the cascading system includes a first port and N power modules, N may be an integer greater than or equal to 2. Each of the power modules includes a first port and a second port. First ports of the N power modules are connected in series and are then connected to the first port of the cascading system.

By controlling a voltage across the first port of at least one power module of the N power modules to be between a voltage corresponding to an n1-th level and a voltage corresponding to an n2-th level during part of time in a switching period, the cascading system is enabled to operate in a current discontinuous conduction mode, where n1 and n2 are adjacent integers. The n1-th level and the n2-th level are module levels.

For example, for a two-level module, the output voltage has two levels, with levels of 0 level and 1 level; for a three-level module, the output voltage has three levels, with levels of −1 level, 0 level, and 1 level; for a five-level module, the output voltage has five levels, with corresponding levels of −2 level, −1 level, 0 level, 1 level, and 2 level, respectively. Similarly, assuming the output level is n, for different topologies of the cascading system, the output voltage is n multiplied by (Vdc/m). The same number of DC capacitors are connected in series to form m sets of output voltages, and different multilevel circuits have different values for m, where Vdc is a voltage across the second port of each of the power modules. In FIG. 3, V_{g} is the voltage across the first port of the cascading system, i.e., an input voltage.

As described above, by controlling turning-on and turning-off time of each switch in each of the power modules and timing between various power modules, it is possible to control rise time, current fall time, and current discontinuity time of the current flowing through the first port of the cascading system, thereby achieving discontinuous inductor current flow and zero steady-state error tracking of the reference value, so that the cascading system operates in a current discontinuous conduction mode. A solution of controlling the cascading system under a light load is provided, which can reduce a turning-on current of the power module under the light load, achieve zero-current turning-on, and improve efficiency under the light load.

In a possible design, the light load may refer to a load that is less than 20%. In an actual working condition, a corresponding range of the light load may also be set according to an actual situation, which is not limited in the embodiment of the present application.

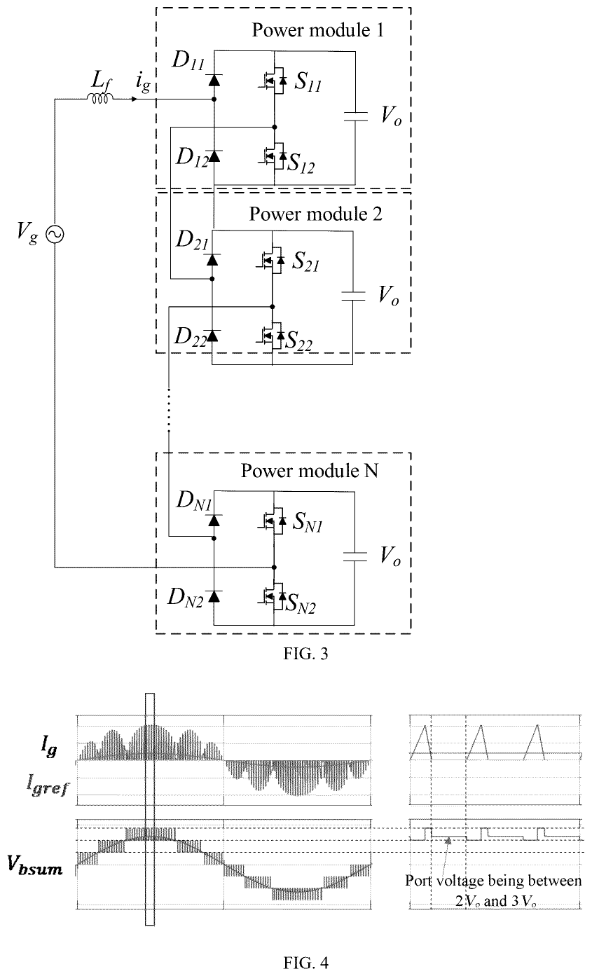

FIG. 4 is a schematic diagram of a simulation effect according to an embodiment of the present application. A cascading system composed of three power modules is taken as an example in a simulation experiment. Specifically, N=3, a total bridge arm voltage of the three power modules is controlled to be between 2Vo and 3Vo for a period of time after the inductor current drops to zero, so that it is neither 2 level nor 3 level, to achieve discontinuity of the inductor current under a light load. Vo represents an output voltage of the power module, i.e., Vdc. In addition, Ig, Igref and Vbsum in FIG. 4 respectively represent a current value (i.e., an inductor current value), a current setpoint value, and a port voltage after first ports of N power modules are connected in series.

In a possible design, through carrier phase-shifting, a voltage across the first port of at least one power module in the cascading system may be controlled to be between a voltage corresponding to an n1-th level and a voltage corresponding to an n2-th level during part of time in a switching period.

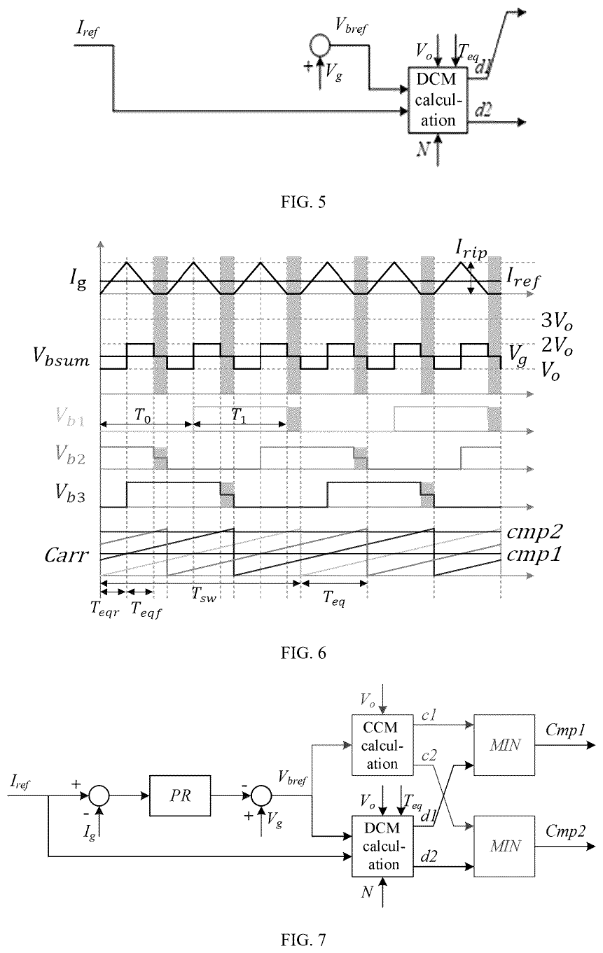

Specifically, as shown in FIG. 5, carrier signals corresponding to the N power modules may be phase-shifted by 2π/N in sequence firstly. Then, according to an inductance of an inductor (L_{f} as shown in FIG. 3), an equivalent switching cycle T_{eq} of the cascading system, a current setpoint I_{ref} of a first port of the cascading system, a voltage setpoint V_{bref} across the first port of the cascading system, and a voltage Vo across a second port of the power module and N, a calculation may be performed based on the cascading system operating in a current discontinuous conduction mode, to generate a first duty cycle d1 and a second duty cycle d2. Then, a driving signal of a switch in each of the power modules according to the first duty cycle d1, the second duty cycle d2, and the carrier signal of each of the power modules. Corresponding control of a voltage across the first port of a corresponding power module is achieved based on the driving signal, and the discontinuity of an inductor current is achieved.

In a possible design, a possible implementation of calculating based on the cascading system operating in the current discontinuous conduction mode, i.e., calculating the first duty cycle and the second duty cycle through the DCM shown in FIG. 5, may be achieved through the following formulas (1), (2), and (5) to (8).

$${T}_{eqr} = \sqrt{2 {T}_{eq} {I}_{ref} {L}_{f} \cdot \frac{( {V}_{o} - {V}_{gx} )}{{V}_{o} {V}_{gx}}} \qquad ( 1 )$$

$${T}_{eqf} = \sqrt{2 {T}_{eq} {I}_{ref} {L}_{f} \cdot \frac{{V}_{gx}}{{V}_{o} ( {V}_{o} - {V}_{gx} )}} \qquad ( 2 )$$

The formula (1) is used to calculate a current rise time T_{egr}, and the formula (2) is used to calculate a current fall time T_{egf}, where V_{gx} equals to V_{g}−nVₒ.

The voltage setpoint V_{gx} of the first port may be obtained through the following formulas (3) and (4).

$$n = floor ( \frac{{V}_{g}}{{V}_{o}} ) \qquad ( 3 )$$

$${V}_{gx} = {V}_{g} - {nV}_{o} \qquad ( 4 )$$

In combination with the formula (3), a current error is obtained according to the current setpoint I_{ref} of the first port of the cascading system and a current feedback value of the first port of the cascading system, and an intermediate voltage nVₒ is obtained by modulating the current error. V_{gx} is obtained by subtracting the intermediate voltage from a voltage of a voltage source V_{g}, as shown in the formula (4).

The current rise time T_{egr} and the current fall time T_{egf} are obtained through calculation in combination with the formulas (1) and (2); further, respective conduction times of upper and lower switches in the cascading system are calculated respectively through the following formulas (5) and (6):

$${T}_{0} = ( N - n - 1 ) {T}_{eq} + {T}_{eqr} \qquad ( 5 )$$

$${T}_{1} = {nT}_{eq} + {T}_{eqf} \qquad ( 6 )$$

where T₀ and T₁ respectively represent the conduction time of the upper switch such as S11 and the conduction time of the lower switch such as S12.

Furthermore, the first duty cycle d1 and the second duty cycle d2 are generated based on the conduction times through formulas (7) and (8):

$${d}_{1} = {T}_{0} / {T}_{s w} \qquad ( 7 )$$

$${d}_{2} = ( {T}_{0} + {T}_{1} ) / {T}_{sw} \qquad ( 8 )$$

where T_{sw} represents a switching period.

In combination with FIG. 5, after the first duty cycle d1 and the second duty cycle d2 are generated, the driving signal of the switch in each of the power modules is determined according to the first duty cycle, the second duty cycle and the carrier signal of each of the power modules. For example, when the carrier signal is less than the first duty cycle d1, Sᵢ₁ is conducted; when the carrier signal is between the first duty cycle d1 and the second duty cycle d2, Sᵢ₂ is conducted; when the carrier signal is greater than the second duty cycle d2, driving signal is locked for both Sᵢ₁ and Sᵢ₂. Thus, during part of time in a switching period, the driving signal of the i-th power module is locked, and the voltage across the first port of the i-th power module is controlled to be between 0 and Vₒ, achieving discontinuity of the inductor current.

FIG. 6 is a schematic diagram of implementing DCM based on carrier phase-shifting according to an embodiment of the present application.

In some embodiments, the voltage setpoint of the first port of the cascading system may be equal to a voltage of the voltage source, such as V_{g} in FIG. 3.

In some embodiments, a control method for a cascading system according to an embodiment of the present application may also achieve seamless switching between a CCM mode and a DCM mode. Referring to FIG. 7, according to the voltage setpoint V_{bref} of the first port and the voltage Vo across the second port of the power module, a calculation may be performed based on the cascading system operating in the current continuous conduction mode, that is, through the CCM calculation as shown in FIG. 7, to obtain a third duty cycle c1 and a fourth duty cycle c2. Further, the driving signal of the switch in each power module is determined according to a minimum value cmp1 of the first duty cycle d1 and the third duty cycle c1, a minimum value cmp2 of the second duty cycle d2 and the fourth duty cycle c2, and the carrier signal of each of the power modules. Corresponding control of a voltage across the first port of a corresponding power module is achieved based on the driving signal, and discontinuity of an inductor current is achieved.

The possible implementations of the CCM calculation are not limited in the embodiment of the present application, which may be any implementation in related technologies.

Comparing FIG. 5 and FIG. 7, it can be seen that in the DCM mode shown in FIG. 5, a closed-loop control may be performed, or directly let V_{bref}=V_{g}. However, in the CCM mode shown in FIG. 7, a closed-loop control is necessary. When the closed-loop control is used, V_{g} in a corresponding formula for a DCM calculation in the embodiment shown in FIG. 5 needs to be replaced with V_{bref}. An automatic switching diagram of the CCM mode and the DCM mode in FIG. 7 shows that, compared to a full range DCM mode shown in FIG. 5, FIG. 7 can achieve automatic switching, which has a better control effect.

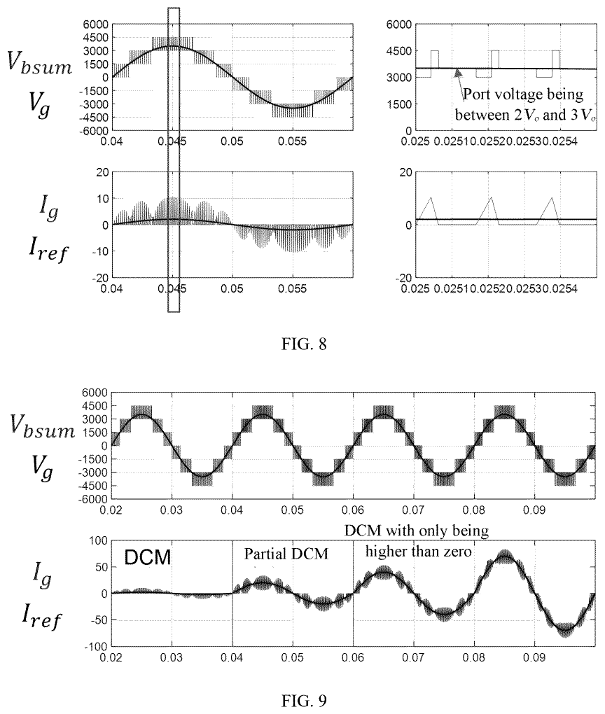

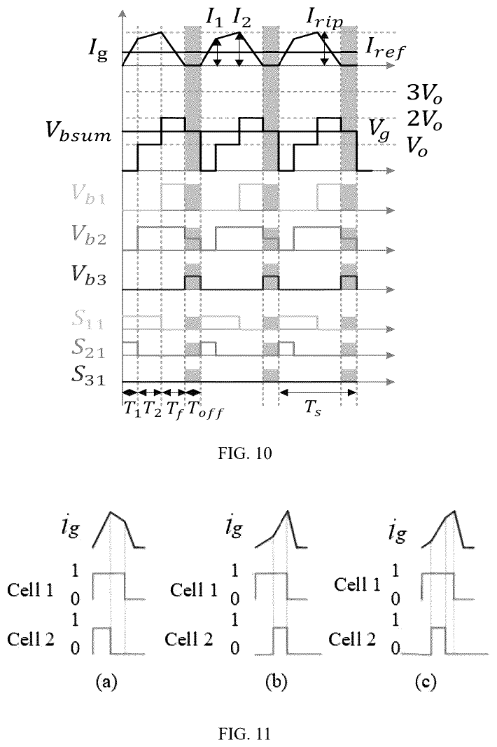

FIG. 8 is a schematic diagram of another simulation effect according to an embodiment of the present application. As shown in FIG. 8 and FIG. 9, under a relatively light load as shown in FIG. 8, the voltage across the first port of at least one power module is controlled to be between voltages corresponding to adjacent two levels, for example, between 2Vo and 3Vo in the figure. At this time, the inductor current is discontinuous, which can achieve zero-current turning-on, reduce switching loss, and improve efficiency under the light load. As shown in FIG. 9, time of the DCM mode varies under different loads. A CCM mode is dominant under a heavy load, a partial CCM mode under a light load, and a full DCM mode under an extremely light load. Through automatic switching between the CCM mode and the

DCM mode, inductor currents under different loads can follow the current setpoint without steady-state error.

In some embodiments, controlling the cascading system under the light load based on carrier phase-shifting as described above has advantages of being simple to implement and beneficial for distributed control. Such means of control is applicable to both centralized control and the distributed control. For example, the closed-loop control algorithm and the DCM calculation formula described above can be implemented in both a centralized controller and a module controller, which is not limited in the embodiment of the present application.

In a possible design, as shown in FIG. 3, a cascading system includes a first port and N power modules, N is an integer greater than or equal to 2, each of the power modules includes a first port and a second port, first ports of the N power modules are connected in series and are then connected to the first port of the cascading system. The cascading system further includes an inductor, and the first port of the cascading system is connected to a voltage source through the inductor. Through quadrilateral DCM control, a voltage across the first port of at least one power module in the cascading system may be controlled to be between a voltage corresponding to an n1-th level and a voltage corresponding to an n2-th level during part of time in a switching period.

For example, the number of high-frequency power modules may be determined to be one or two according to the voltage of the voltage source in the cascading system, that is to say, one or two power modules in the cascading system are controlled to be in a high-frequency modulation mode to achieve the control of the cascading system under the light load. The high-frequency power module refers to a power module operating in the high-frequency modulation mode.

Specifically, it can be determined, according to the voltage of the voltage source, that there are one or two high-frequency power modules. For example, if a ratio of the voltage of the voltage source to N times a voltage across the second port of the power module is less than a preset ratio, e.g.,

$$\frac{{V}_{g}}{N * {V}_{o}} < a preset ratio ,$$

then it is determined that the number of high-frequency power modules is one, and remaining power modules remain in a zero level state; if a ratio of the voltage of the voltage source to N times a voltage across the second port of the power module is greater than or equal to the preset ratio, e.g.,

$$\frac{{V}_{g}}{N * {V}_{o}} ⩾ the preset ratio ,$$

then it is determined that the number of high-frequency power modules is two, and remaining power modules maintain in a zero level or 1 level state according to a voltage relationship. In some embodiments, the preset ratio may be 0.2.

Further, when there are 2 high-frequency power modules, if an input voltage, such as V_{g}, of the high-frequency power module is an integer multiple of an output voltage, such as Vo, then the 2 high-frequency power modules are synchronously controlled; if an input voltage, such as V_{g}, of the high-frequency power module is not an integer multiple of an output voltage, such as Vo, the 2 high-frequency power modules are non-synchronously controlled, as shown in FIG. 10.

In a possible design, a manner of non-synchronously controlling the high-frequency power modules may include various situations as shown in FIG. 11.

For example, the non-synchronously controlling may include one of the following situations: simultaneously turning on the high-frequency power modules and non-simultaneously turning off the high-frequency power modules as shown in FIG. 11(a); non-simultaneously turning on the high-frequency power modules and simultaneously turning off the high-frequency power modules as shown in FIG. 11(b); or non-simultaneously turning on the high-frequency power modules and non-simultaneously turning off the high-frequency power modules as shown in FIG. 11(c). In FIG. 11, Cell 1 and Cell 2 represent two high-frequency power modules, respectively.

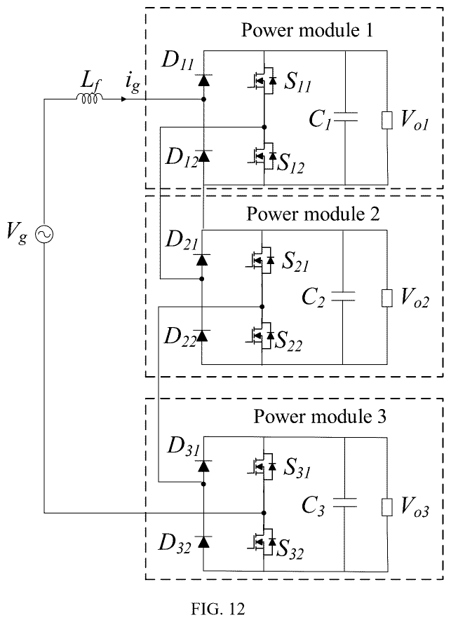

In a possible design, such as the cascading system shown in FIG. 12, after the number of high-frequency power modules is determined, the high-frequency power module(s) can be determined by time-based rotation or sequential rotation of the N power modules. It should be noted that FIG. 12 shows three power modules as an example, which is not a limitation on the number of power modules.

Specifically, for example, the time-based rotation may be performed though a counter. Firstly, a counter is initialized to 0, and after a calculation of the duty cycle of each power module is completed, the counter may determine which power module in a current group to be the high-frequency power module. For example, if the counter is less than the number of power modules, the power module in a first group is determined as the high-frequency power module; if the counter is greater than the number of power modules but less than twice the number of power modules, the power module in a second group is determined as the high-frequency power module; if the counter is greater than twice the number of power modules but less than three times the number of power modules, the power module in a third group is determined as the high-frequency power module; if the counter is greater than three times the number of power modules, the counter is set to zero, and the duty cycle of each group is recalculated.

A manner of the sequential rotation may be used, for example, sorting is performed on the output voltage of each of the power modules in the cascading system after the calculation of the duty cycle of each of the power modules is completed. The power module with a relatively high output voltage is selected to maintain at a 0 level (i.e., bypass), the power module with a relatively low output voltage is selected to maintain at a 1 level, and the duty cycle of each of the power modules is allocated. A determining standard for the relatively high output voltage and the relatively low output voltage may be achieved by setting corresponding voltage thresholds. For example, those greater than the voltage threshold are considered as relatively high output voltages, while those less than or equal to the voltage threshold are considered relatively low output voltages.

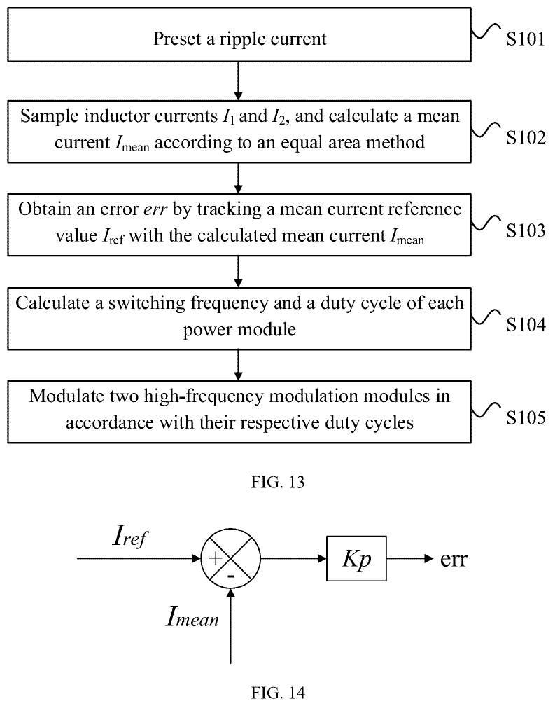

In some embodiments, a calculation of the duty cycle of each of the power modules and a switching frequency in the non-synchronous control of the cascading system under the light load achieved by the quadrilateral DCM control is shown in FIG. 13. Please refer to FIG. 10 and FIG. 13 simultaneously. FIG. 13 is a schematic diagram of a calculation process of a duty cycle and a switching frequency according to an embodiment of the present application. As shown in FIG. 13, the embodiment of the present application includes the following.

S101, preset a ripple current.

Iᵣᵢₚ is the ripple current, I_{ref} is a mean current reference value, Iₓₛₑₜ is a ripple parameter setting value. The ripple current may be preset by the following formula (9):

$${I}_{rip} = 2 ( {I}_{ref} + {I}_{xset} ) \qquad ( 9 )$$

S102, sample inductor currents I₁ and I₂, and calculate a mean current Iₘₑₐₙ according to an equal area method.

Referring to formulas (10) to (13), T₁ denotes the duration for the inductor current to rise to I₁, that is, the duration when a power module 2 is turned on, T₂ denotes the duration for the inductor current to rise from I₁ to I₂, a sum of T₁and T₂ is the duration when the power module 1 is turned on, T_{f} denotes the duration for the inductor current to drop from I₂ to 0, T_{off} denotes the duration when the inductor current is 0, T_{sw} denotes a switching period, V_{g} denotes the input voltage, and Vₒ denotes the output voltage,

$${T}_{1} = \frac{{I}_{1} * {L}_{f}}{{V}_{g}} \qquad ( 10 )$$

$${T}_{2} = \frac{( {I}_{2} - {I}_{1} ) * {L}_{f}}{{V}_{g} - {V}_{o}} \qquad ( 11 )$$

$${T}_{f} = \frac{{I}_{2} * {L}_{f}}{2 {V}_{o} - {V}_{g}} \qquad ( 12 )$$

$${T}_{sw} * {I}_{mean} = \frac{1}{2} * {I}_{1} * {T}_{1} + \frac{1}{2} * ( {I}_{1} + {I}_{2} ) * {T}_{2} + \frac{1}{2} * {I}_{2} * {T}_{f} \qquad ( 13 )$$

S103, obtain an error err by tracking the mean current reference value I_{ref} with the calculated mean current Iₘₑₐₙ.

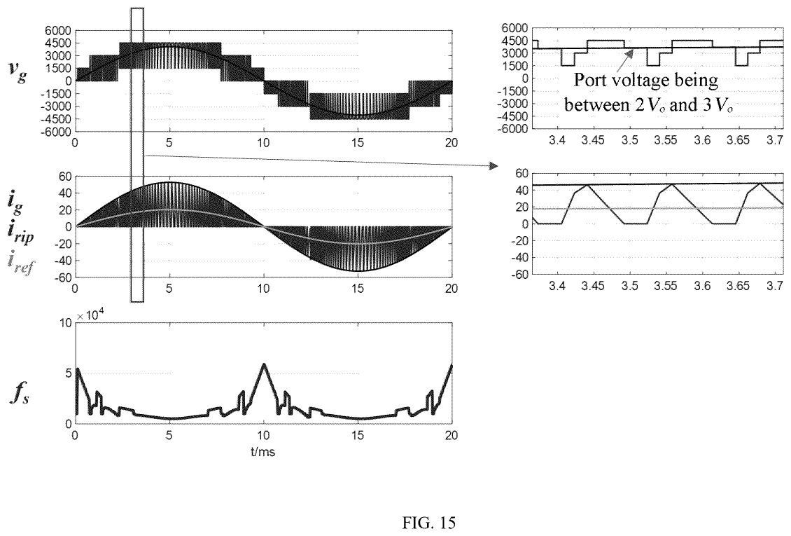

As shown in FIG. 14, the error err is obtained by tracking the mean current reference value I_{ref} with the calculated mean current Iₘₑₐₙ, where Kₚ is a scaling factor.

S104, calculate a switching frequency and a duty cycle of each power module.

For example, the turning-on duration of the power module 1 is set as a times the turning-on duration of the power module 2, and the turning-on duration T₁ of the power module 1 is calculated according to formula (14):

$${T}_{1} = \frac{{I}_{rip} * {L}_{f}}{a * {V}_{g} - a * {V}_{o} + {V}_{o}} \qquad ( 14 )$$

a sum of the duty cycle of the power module 1 and the duty cycle of the power module 2 is dₛᵤₘₛₑₜ, as shown in formula (15) below:

$${d}_{sumset} = {d}_{{1}^{′}} + {d}_{{2}^{′}} = \frac{{T}_{1} * ( 1 + a )}{{T}_{s}} \qquad ( 15 )$$

the error err obtained in S103 is introduced into the following formula (16):

$${d}_{sum} = {d}_{sumset} + err \qquad ( 16 )$$

thus, the duty cycle d1, of the power module 1, the duty cycle d2, of the power module 2, and the switching frequency fs are obtained through calculations, as shown in the following formulas (17) to (20):

$${d}_{{1}^{′}} = \frac{{d}_{sum} * a}{( 1 + a )} \qquad ( 17 )$$

$${d}_{{2}^{′}} = \frac{{d}_{sum}}{( 1 + a )} \qquad ( 18 )$$

$${T}_{s} = \frac{{T}_{1}}{{d}_{2}} \qquad ( 19 )$$

$${f}_{s} = \frac{1}{{T}_{s}} \qquad ( 20 )$$

S105, modulate two high-frequency modulation modules in accordance with their respective duty cycles.

For example, after conduction for a period of time, locking is performed for a power module Sᵢ₁, and after continued conduction for a period of time, locking is performed for a power module Sᵢ₂. During the duration T_{off} when both upper and lower switches are locked, the voltage across the port of the power module is controlled to be between two levels.

It can be seen from the description in the above embodiments that the cascading system operates in a DCM mode through quadrilateral DCM control, an operating effect is shown in FIG. 15, which can achieve the controlling of the cascading system under a light load, reduce the switching frequency, and some switches can achieve zero-current turning-on or zero-current turning-off, thereby reducing switching losses and improving efficiency under the light load.

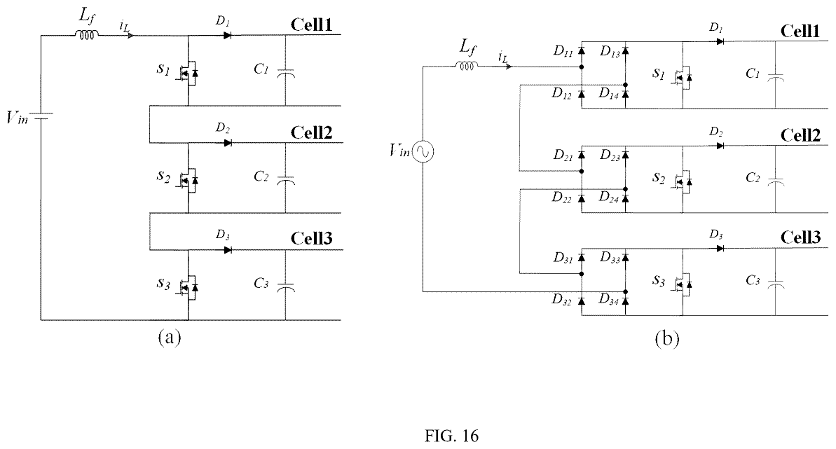

In a possible design, the control method for the cascading system provided in the embodiment of the present application may support multiple cascading system structures, for example, including a DC/DC cascading system, a Boost cascading system and an AC/DC cascading system shown in FIG. 16(a), and a Boost PFC cascading system shown in FIG. 16(b). The specific structure of the cascading system is not limited in the embodiment of the present application. In FIG. 16, Cell 1, Cell 2 and Cell 3 represent power modules.

The cascading system according to the embodiment of the present application further includes:
a control unit, configured to implement the control method for the cascading system provided in the above embodiments, for example, control a voltage across a first port of at least one power module to be between a voltage corresponding to an n1-th level and a voltage corresponding to an n2-th level during part of time in a switching period, so that the cascading system operates in a current discontinuous conduction mode, where n1 and n2 are adjacent integers.

In a possible design, the cascading system further includes an inductor, the first port of the cascading system is connected to a voltage source through the inductor, and the control unit is specifically configured to:
phase-shift carrier signals corresponding to N power modules by 2π/N in sequence;
according to an inductance of the inductor, an equivalent switching frequency of the system, a current setpoint of the first port of the cascading system, a voltage setpoint of the first port of the cascading system, and a voltage across a second port of the power module and N, perform a calculation based on the cascading system operating in the current discontinuous conduction mode, to generate a first duty cycle and a second duty cycle;
determine a driving signal of a switch in each of the power modules according to the first duty cycle, the second duty cycle, and the carrier signal of each of the power modules.

In a possible design, the voltage setpoint of the first port of the cascading system is equal to a voltage of the voltage source.

In a possible design, the control unit is further configured to:
obtain a current error according to the current setpoint of the first port of the cascading system and a current feedback value of the first port of the cascading system, and modulate the current error to obtain an intermediate voltage; and
subtract the intermediate voltage from the voltage of the voltage source to obtain the voltage setpoint of the first port of the cascading system.

In a possible design, the control unit is further configured to:
according to the voltage setpoint of the first port and the voltage across the second port of the power module, perform a calculation based on the cascading system operating in the current continuous conduction mode, to obtain a third duty cycle and a fourth duty cycle; and determine the driving signal of the switch in each of the power modules according to a minimum value of the first duty cycle and the third duty cycle, a minimum value of the second duty cycle and the fourth duty cycle, and the carrier signal of each of the power modules.

In a possible design, the cascading system further includes an inductor, the first port of the cascading system is connected to a voltage source through the inductor, and the control unit is further configured to:
determine a number of high-frequency power modules to be one or two according to a voltage of the voltage source, where the high-frequency power module refers to a power module operating in a high-frequency modulation mode.

In a possible design, the control unit is further configured to:
if a ratio of the voltage of the voltage source to N times a voltage across the second port of the power module is less than a preset ratio, determine that the number of high-frequency power modules is one;
if a ratio of the voltage of the voltage source to N times a voltage across the second port of the power module is greater than or equal to the preset ratio, determine that the number of high-frequency power modules is two.

In a possible design, the preset ratio is 0.2.

In a possible design, when there are 2 high-frequency power modules, the control unit is further configured to:
if an input voltage of the high-frequency power module is an integer multiple of an output voltage, synchronously control the high-frequency power modules; and
if an input voltage of the high-frequency power module is not an integer multiple of an output voltage, non-synchronously control the high-frequency power modules.

In a possible design, the non-synchronously controlling includes one of the following situations: simultaneously turning on the high-frequency power modules and non-simultaneously turning off the high-frequency power modules; non-simultaneously turning on the high-frequency power modules and simultaneously turning off the high-frequency power modules; or non-simultaneously turning on the high-frequency power modules and non-simultaneously turning off the high-frequency power modules.

In a possible design, the high-frequency power module is determined by time-based rotation or sequential rotation of the N power modules.

Those skilled in the art will readily conceive other implementations of the present application after considering the specification and practicing the invention disclosed herein. The present application is intended to cover any variations, uses, or adaptive changes of the present application, which follow the general principles of the present application and include common knowledge or conventional technical means in the art not disclosed in the present application. The specification and embodiments are only considered exemplary, and the true scope and spirit of the present application are indicated by the claims.

It should be understood that the present application is not limited to the precise structure described above and shown in the accompanying drawings, and various modifications and changes may be made without departing from the scope of the present application. The scope of the present application is subject to only the appended claims.

What is claimed is:

1. A control method for a cascading system, wherein the cascading system comprises a first port and N power modules, N is an integer greater than or equal to 2, each of the power modules comprises a first port and a second port, first ports of the N power modules are connected in series and are then connected to the first port of the cascading system; the control method comprises:
controlling a voltage across the first port of at least one power module to be between a voltage corresponding to an n1-th level and a voltage corresponding to an n2-th level during part of time in a switching period, so that the cascading system operates in a current discontinuous conduction mode, wherein n1 and n2 are adjacent integers.

2. The control method according to claim 1, wherein the cascading system further comprises an inductor, the first port of the cascading system is connected to a voltage source through the inductor, the controlling the voltage across the first port of the at least one power module to be between the voltage corresponding to the n1-th level and the voltage corresponding to the n2-th level during part of time in the switching period comprises:
phase-shifting carrier signals corresponding to the N power modules by 2π/N in sequence;
according to an inductance of the inductor, an equivalent switching frequency of the cascading system, a current setpoint of the first port of the cascading system, a voltage setpoint of the first port of the cascading system, and a voltage across the second port of the power module and N, performing a calculation based on the cascading system operating in the current discontinuous conduction mode, to generate a first duty cycle and a second duty cycle;
determining a driving signal of a switch in each of the power modules according to the first duty cycle, the second duty cycle, and the carrier signal of each of the power modules.

3. The control method according to claim 2, wherein the voltage setpoint of the first port of the cascading system is equal to a voltage of the voltage source.

4. The control method according to claim 2, further comprising:
obtaining a current error according to the current setpoint of the first port of the cascading system and a current feedback value of the first port of the cascading system, and modulating the current error to obtain an intermediate voltage; and
subtracting the intermediate voltage from the voltage of the voltage source to obtain the voltage setpoint of the first port of the cascading system.

5. The control method according to claim 4, further comprising:
according to the voltage setpoint of the first port and the voltage across the second port of the power module, performing a calculation based on the cascading system operating in a current continuous conduction mode, to obtain a third duty cycle and a fourth duty cycle; and
determining the driving signal of the switch in each of the power modules according to a minimum value of the first duty cycle and the third duty cycle, a minimum value of the second duty cycle and the fourth duty cycle, and the carrier signal of each of the power modules.

6. The control method according to claim 1, wherein the cascading system further comprises an inductor, the first port of the cascading system is connected to a voltage source through the inductor, the controlling the voltage across the first port of the at least one power module to be between the voltage corresponding to the n1-th level and the voltage corresponding to the n2-th level during part of time in the switching period comprises:
determining a number of high-frequency power modules to be one or two according to a voltage of the voltage source, wherein the high-frequency power module refers to a power module operating in a high-frequency modulation mode.

7. The control method according to claim 6, wherein the determining the number of high-frequency power modules according to the voltage of the voltage source comprises:
if a ratio of the voltage of the voltage source to N times a voltage across the second port of the power module is less than a preset ratio, determining that the number of high-frequency power modules is one;
if a ratio of the voltage of the voltage source to N times a voltage across the second port of the power module is greater than or equal to the preset ratio, determining that the number of high-frequency power modules is two.

8. The control method according to claim 7, wherein the preset ratio is 0.2.

9. The control method according to claim 6, wherein when the number of high-frequency power modules is two, further comprising:
if an input voltage of the high-frequency power module is an integer multiple of an output voltage, synchronously controlling the high-frequency power modules; and
if an input voltage of the high-frequency power module is not an integer multiple of an output voltage, non-synchronously controlling the high-frequency power modules;
wherein the non-synchronously controlling comprises one of the following situations: simultaneously turning on the high-frequency power modules and non-simultaneously turning off the high-frequency power modules; non-simultaneously turning on the high-frequency power modules and simultaneously turning off the high-frequency power modules; or non-simultaneously turning on the high-frequency power modules and non-simultaneously turning off the high-frequency power modules.

10. The control method according to claim 6, wherein the high-frequency power module is determined by time-based rotation or sequential rotation of the N power modules.

11. A cascading system, comprising: a first port and N power modules, wherein Nis an integer greater than or equal to 2, each of the power modules comprises a first port and a second port, first ports of the N power modules are connected in series and are then connected to the first port of the cascading system; and
a control unit, configured to control a voltage across the first port of at least one power module to be between a voltage corresponding to an n1-th level and a voltage corresponding to an n2-th level during part of time in a switching period, so that the cascading system operates in a current discontinuous conduction mode, wherein n1 and n2 are adjacent integers.

12. The cascading system according to claim 11, wherein the cascading system further comprises an inductor, the first port of the cascading system is connected to a voltage source through the inductor, and the control unit is specifically configured to:
phase-shift carrier signals corresponding to the N power modules by 2π/N in sequence;
according to an inductance of the inductor, an equivalent switching frequency of the system, a current setpoint of the first port of the cascading system, a voltage setpoint of the first port of the cascading system, a voltage across the second port of the power module and N, perform a calculation based on the cascading system operating in the current discontinuous conduction mode, to generate a first duty cycle and a second duty cycle;
determine a driving signal of a switch in each of the power modules according to the first duty cycle, the second duty cycle, and the carrier signal of each of the power modules.

13. The cascading system according to claim 12, wherein the voltage setpoint of the first port of the cascading system is equal to a voltage of the voltage source.

14. The cascading system according to claim 12, wherein the control unit is further configured to:
obtain a current error according to the current setpoint of the first port of the cascading system and a current feedback value of the first port of the cascading system, and modulate the current error to obtain an intermediate voltage; and
subtract the intermediate voltage from the voltage of the voltage source to obtain the voltage setpoint of the first port of the cascading system.

15. The cascading system according to claim 14, wherein the control unit is further configured to:
according to the voltage setpoint of the first port and the voltage across the second port of the power module, perform a calculation based on the cascading system operating in the current continuous conduction mode, to obtain a third duty cycle and a fourth duty cycle; and
determine the driving signal of the switch in each of the power modules according to a minimum value of the first duty cycle and the third duty cycle, a minimum value of the second duty cycle and the fourth duty cycle, and the carrier signal of each of the power modules.

16. The cascading system according to claim 11, further comprising: an inductor, wherein the first port of the cascading system is connected to a voltage source through the inductor, and the control unit is further configured to:
determine a number of high-frequency power modules to be one or two according to a voltage of the voltage source, wherein the high-frequency power module refers to a power module operating in a high-frequency modulation mode.

17. The cascading system according to claim 16, wherein the control unit is further configured to:
if a ratio of the voltage of the voltage source to N times a voltage across the second port of the power module is less than a preset ratio, determine that the number of high-frequency power modules is one;
if a ratio of the voltage of the voltage source to N times a voltage across the second port of the power module is greater than or equal to the preset ratio, determine that the number of high-frequency power modules is two.

18. The cascading system according to claim 17, wherein the preset ratio is 0.2.

19. The cascading system according to claim 16, wherein when the number of high-frequency power modules is two, the control unit is further configured to:
if an input voltage of the high-frequency power module is an integer multiple of an output voltage, synchronously control the high-frequency power modules; and
if an input voltage of the high-frequency power module is not an integer multiple of an output voltage, non-synchronously control the high-frequency power modules;
wherein the non-synchronously controlling comprises one of the following situations: simultaneously turning on the high-frequency power modules and non-simultaneously turning off the high-frequency power modules; non-simultaneously turning on the high-frequency power modules and simultaneously turning off the high-frequency power modules; or non-simultaneously turning on the high-frequency power modules and non-simultaneously turning off the high-frequency power modules.

20. The cascading system according to claim 16, wherein the high-frequency power module is determined by time-based rotation or sequential rotation of the N power modules.
